(19) United States
(12) Patent Application Publication
(10) Pub. No.: US 2004/0123715 A1
(43) Pub. Date: Jul. 1, 2004

(54) Credit card cutting machine

(75) Inventors: Robert W. Stuckel, Arlington Heights, IL (US); Kimberly Sue Wilson, Highland Park, IL (US); Nicole Marie Machnowski, Chicago, IL (US)

Correspondence Address: SIDLEY AUSTIN BROWN & WOOD LLP, 717 NORTH HARWOOD, SUITE 3400, DALLAS, TX, 75201, US

(73) Assignee: DISCOVER FINANCIAL SERVICES, INC.

(21) Appl. No.: 10/669,581

(22) Filed: Sep. 24, 2003

Related U.S. Application Data
(60) Provisional application No. 60/435,802, filed on Dec. 20, 2002.

(51) Int. Cl. B26D 1/12; B26F 1/14

(52) U.S. Cl. 83/684; 83/669

(57) ABSTRACT

A machine is provided for cutting credit cards, debit cards or special value cards to an unconventional size or shape or alternatively to a smaller rectangular size. The machine includes a feed device, a first conveyor with a plurality of nests for receiving cards from the feed device and transporting them individually to a cutting station, a cutting device for cutting the cards and a delivery device for removing the cut cards from the cutting station.

### CROSS-REFERENCE TO RELATED APPLICATIONS

This application is related to U.S. Provisional Patent Application Serial No. 60/435,802 filed Dec. 20, 2002, the entire contents of each of which are hereby incorporated by reference.

### BACKGROUND OF THE INVENTION

The present invention relates to a machine for cutting credit cards of conventional rectangular shape, to a non-conventional configuration, such as square or asymmetrical shape, or to a smaller rectangular shape.

Suppliers of conventional credit cards, debit cards and special value cards desire to have their particular card carried by the Cardmember in an accessible position outside of a wallet or a purse, for example on a key loop or key chain or in the pocket, in order to increase the likelihood of card usage. The advantage of having the card accessible outside of a wallet or purse is that the Cardmember has the card available at his or her fingertips instead of having to open a purse or wallet and make a choice to use a particular card from among several possible choices.

The size and shape of conventional credit cards makes it disadvantageous to carry them on a key chain. For example, a card of conventional size requires an equally large sized container or holder to cover the card in order to protect against theft of the card itself or the number printed on the card. The rectangular shape also limits the options for container size and shape and access to the card. Key chain containers are inherently limited in size and weight. Bulky or excessively large key chain holders will pull the key when used in a car ignition, or add weight or size to an item that is typically carried in a pocket or a purse. Unconventionally shaped, conventional credit cards or special value cards, of square or asymmetrical configuration have been developed for use with an associated container or case that can be carried in the accessed position on a key chain. Smaller rectangular cards may also be carried in the accessed position in a case on a key chain. There is a need, therefore, for developing equipment to cut conventional credit cards to unconventional size and/or shape.

### SUMMARY OF THE INVENTION

The present invention provides a machine for cutting credit cards to unconventional size and/or shape. The machine includes a feed device for holding a plurality of cards in stacked relationship and removing them one at a time therefrom. A means is provided for receiving the cards from the feed device and transporting them individually to a cutting station. The transport means includes a plurality of nests for holding each card during transport to the cutting station. A cutting device is provided at the cutting station for cutting each card to a new size or shape, and a card delivery mechanism is provided for transporting cut cards away from the cutting station.

In one embodiment the machine includes a feed device comprising a magazine for holding a plurality of cards and a shuttle device having a fork for engaging the edge of each card and individually removing the cards from the magazine. A first conveyor has a plurality of holding nests mounted at spaced locations thereon, each holding nest designed to receive a single card from the shuttle device. A cutting device comprises a punch, a die block and an actuator for pressing the punch into the die block, and a card delivery mechanism comprises a second conveyor aligned transversely of the first for transporting cut cards away from the cutting station.

In another embodiment the machine includes a feed device comprising a walking beam loader and a pick and place mechanism having suction cups for individually removing cards from the loader. A first conveyor has a plurality of holding nests, each designed to receive a single card from the pick and place mechanism. A cutting device comprises a punch, a die block and an actuator for pressing the punch into the die block. A card delivery mechanism comprises a second conveyor aligned transversely of the first for transporting cut cards away from the cutting station. The second conveyor preferably has a plurality of custom nests mounted at spaced locations thereon for receiving and holding the cut cards.

In a further embodiment the machine includes a feed device for holding a plurality of cards and transferring them individually to a plurality of holding nests. A first conveyor having said plurality of holding nests mounted at spaced locations thereon is provided for transporting the cards individually to a cutting station. The machine further includes means for determining whether the cards are properly seated in the nests, means for determining whether the cards are properly oriented in the nests, and means for locating each of said nests in proper position at the cutting station. A cutting device is provided for cutting each card to a new size or shape at the cutting station. A card delivery mechanism is provided for transporting cut cards away from the cutting station. In alternate form the delivery mechanism comprises a pick and place mechanism for removing the cut cards from the nests of the first conveyor and placing them in a container or magazine. In a preferred form, the means for determining whether the cards are properly seated includes a device having a plurality of spaced probes movable downwardly from above the card to push the card down into the nest when the card is not completely seated in the nest. Also, in a preferred form the means for determining whether the cards are properly oriented in the nests includes means for determining whether a magnetic stripe is present on a side of the card facing said orientation determining means.

### BRIEF DESCRIPTION OF THE DRAWINGS

In the drawings, which are not to scale:

FIG. 1 is a perspective view of one embodiment of the machine of the present invention.

FIG. 2 is a top plan view of the machine of FIG. 1.

FIG. 3 is a front view of the machine of FIG. 2.

FIG. 4 is an end view of the machine of FIG. 2.

### DETAILED DESCRIPTION OF THE PREFERRED EMBODIMENTS

The present invention provides a machine for cutting credit cards or special value cards to non-conventional shapes, preferably an asymmetrical or square shape, or in the alternative to a rectangular shape of smaller size.

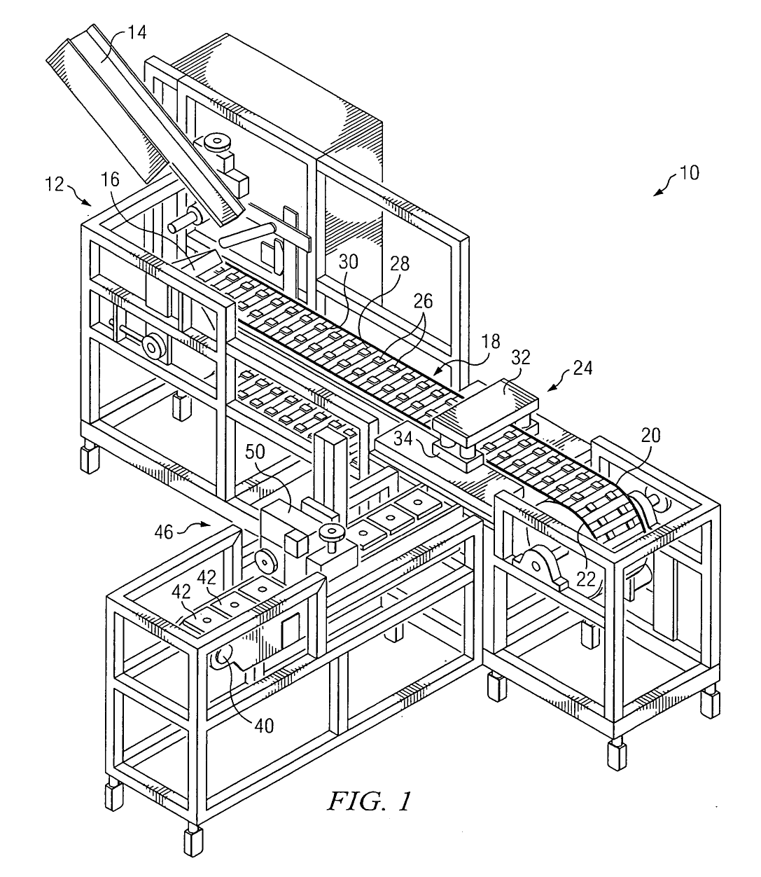

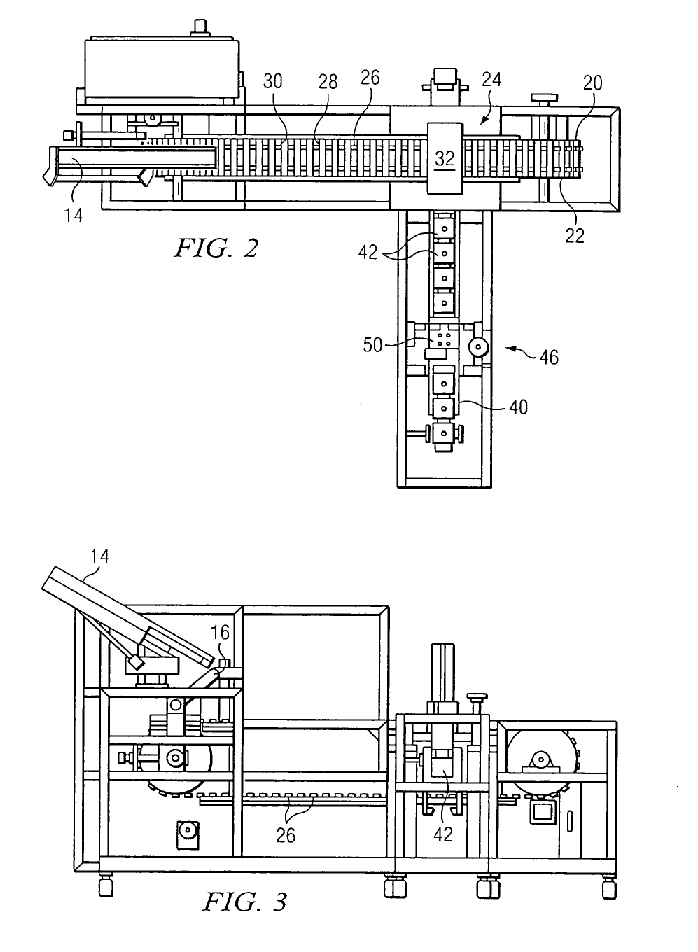

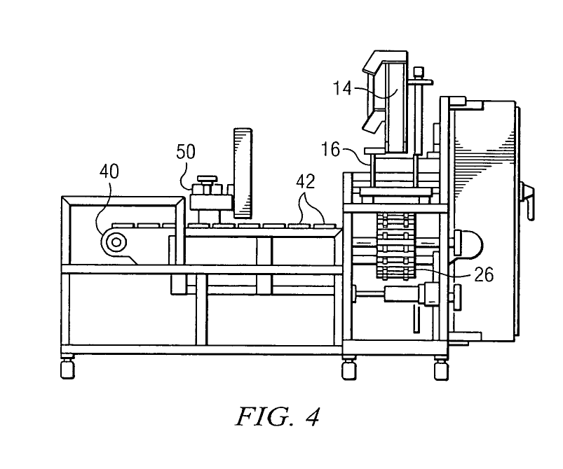

As shown in FIG. 1, the machine 10 has a feed device 12 that includes a magazine 14 for holding a plurality of cards in stacked relationship and a pick and place mechanism 16 for removing the cards one at a time from magazine 14. The pick and place mechanism has a plurality of suction cups (not shown) for contacting a broad face of each card and lifting it from the magazine. Preferably a shuttle device may be used to remove cards from the magazine. The shuttle device has a fork adapted to grasp the edge of a card and transfer the card into the card nests on a conveyor as described below. Alternately, in place of a magazine, a walking beam loader may be provided. The walking beam magazine may index a whole group of cards each time a certain number of cards are removed from the loader, or a stepper motor may be provided to rotate a screw to shift the group one card at a time each time one card is removed. A pick and place mechanism is preferably used with a walking beam loader to remove the cards from the loader and transfer them to the card nests just mentioned. A first conveyor 18 comprising a pair of endless belts 20 and 22 is provided for transporting the cards from feed device 12 to a cutting station 24. A plurality of holding nests 26 are mounted at spaced locations along the length of the first conveyor for receiving cards individually from the pick and place mechanism. Each holding nest includes a pair of parallel sides 28 and 30 connected at opposite ends to belts 20 and 22. Springs are preferably provided (not shown) for pressing sidepieces 28 and 30 toward each other to hold the cards in a secure fashion.

A cutting device is provided at cutting station 24 and preferably includes top and bottom die block sections 32 and 34, one of said sections, preferably the top section, containing a punch insert, the other containing a die insert with a die cavity therein. Preferably a separate insert is provided in the punch for cutting a hole in the card when desired. The inserts are preferably clamped in place by quick-release fasteners. The cutting device also preferably includes a stripper plate (not shown) containing a stripper insert and an actuator (not shown). The actuator may be of the type used in a conventional mechanical punch press; an air cylinder powered press, or an offset rotating device. In all cases, the generating pressure must be no less than five tons for properly cutting the cards. The die stroke is of minimum length, preferably at least three inches, to permit an operator to view the cutting process. Preferably, the die components are mounted in a high precision ball bearing bushing die set. More preferably, aluminum FORTAL die sets supplied by Superior Die Set Company are used. Preferably the punch and die insert are of CPM10v tool steel supplied by Crucible Steel Company.

After cutting, the cards may, in one embodiment, simply drop onto a second conveyor 40 for removing the cut cards from the cutting station. In this embodiment, a blast of air may be provided through a cavity in the punch to assist in removal of the cut card from the nest. Preferably, in another embodiment, second conveyor 40 has a plurality of custom nests 42 sized and shaped to hold the cut cards individually. A pick and place mechanism (not shown) having a suction cup device is preferably provided to engage the underside of each card after it is pushed through the die cavity by the punch. The suction cup device pulls the card downwardly into one of custom nests 42. The conveyor 40 transports the cut cards to a delivery station 46. Another pick and place mechanism is preferably provided at the delivery station 46 to place the cards in a container or magazine 50. Desirably, conveyor 40 is timed to operate in synchronism with the cutting device to coordinate receipt and transport of the cards with the speed at which they are cut. For example, where the cut cards simply drop onto conveyor 40, the conveyor may be timed so that the cards will overlap each other so that an operator may pick up several cards at a time and place them into a box, or the conveyor may be timed so the cards can be placed in a magazine container using a pick and place or other type of mechanism.

Preferably a scrap removal device (not shown) is provided to remove any scrap remaining in the nests of the first conveyor. The scrap removal device may be located advantageously at the left end of the machine as viewed in FIG. 1. The scrap removal device is designed to mechanically remove any remaining scrap from each nest when the nest is in a vertical position in front of the scrap removal device.

In a preferred embodiment, the machine includes means for determining whether the cards are properly seated in the nests on first conveyor 18. Preferably said means for determining seating of the cards includes a plurality of probes movable downwardly from above to push each card into the nest when the card is not properly seated therein. The probes also serve to detect when a card is not present in a nest. In another preferred embodiment, means is provided for checking whether the cards are properly oriented in the nests. Since the cards will have a magnetic stripe on one side, preferably the top side of the card, said orientation checking means may comprise means for determining the presence of a magnetic stripe on the side of the card facing said means. Where the magnetic stripe is of a different color than the rest of the card, said means may comprise a conventional color recognition system. Alternatively, said orientation checking means may comprise a magnetic strip reader/scanner. In a further preferred embodiment, said machine includes means for locating each of said nests in proper position at the cutting station. Said nest locating means may comprise two or more pilot holes in each nest for engagement by posts projecting from one of the die sections for locating the nest in proper position. Said nest locating means may further comprise corner pilot means for precision line-up of the nests by contacting and positioning diagonally opposite corners of the card. Since the cards are die cut to a new shape, a magstripe reader may be placed on the conveyor following the die cut mechanism to read the magstripe and confirm the card magstripe is still functional post-cut.

While one or more preferred embodiments have been identified, other configurations and modifications can be provided which are within the scope of the present invention.

We claim:

1. A machine for cutting financial cards to a non-conventional configuration, said machine comprising:
(a) a card supply mechanism for supplying a plurality of financial cards individually to a cutting station;
(b) a cutting device at said cutting station for cutting said financial cards to said non-conventional configuration; and
(c) a card delivery mechanism for transporting said cut financial cards away from said cutting station.

2. The machine of claim 1, wherein said card supply mechanism includes a first conveyor that has a plurality of spaced nests for holding said financial cards during transport to said cutting station, each of said spaced nests being adapted to hold one of said financial cards therein.

3. The machine of claim 2, wherein said first conveyor comprises a pair of transversely spaced endless belts and each of said nests comprises a pair of spaced parallel sidepieces connected at opposite ends to said belts.

4. The machine of claim 4, wherein said first conveyor extends through said cutting station and each said financial card is cut while held within one of said nests on said first conveyor at the cutting station.

5. The machine of claim 2, wherein said card supply mechanism further includes a magazine for holding said plurality of cards in stacked relationship and a mechanism for individually removing said cards from said magazine and placing them in one of the nests on said first conveyor.

6. The machine of claim 5, wherein said mechanism for individually removing said cards from said magazine comprises a shuttle device having a fork adapted to grasp the edge of each card, remove said card from the magazine, and place said card in one of the nests on said first conveyor.

7. The machine of claim 2, wherein said card supply mechanism further includes a walking beam loader and a card supply pick and place mechanism having suction cups for individually removing said cards from the walking beam loader and placing them in one of the nests on said first conveyor.

8. The machine of claim 1, wherein said cutting device comprises a punch, a die block and an actuator for pressing said punch into said die block.

9. The machine of claim 2, wherein said card delivery mechanism comprises a second conveyor for transporting said cut financial cards away from said cutting station to a delivery station.

10. The machine of claim 9, wherein said first conveyor has upper and lower portions and said second conveyor extends transversely of said first conveyor between the upper and lower portions of said first conveyor.

11. The machine of claim 10, wherein said second conveyor comprises a pair of transversely spaced endless belts and a plurality of spaced nests connected to said spaced endless belts, each of said spaced nests being adapted to hold one of said cut financial cards therein.

12. The machine of claim 11, wherein each of said nests of the second conveyor comprises a pair of spaced parallel sidepieces connected at opposite ends to said endless belts of the second conveyor.

13. The machine of claim 11, wherein said card delivery mechanism further comprises a first card delivery pick and place mechanism for engaging an underside of each card at the cutting station and pulling the cut card down into one of said spaced nests on said second conveyor.

14. The machine of claim 13, wherein said card delivery mechanism further comprises a second card delivery pick and place mechanism at said delivery station for removing cut cards from the nests on the second conveyor and placing them in a container.

15. The machine of claim 9, wherein said second conveyor is timed to operate in synchronism with the cutting device to coordinate receipt and transport of the cut cards with the speed at which said cards are cut.

16. The machine of claim 15, wherein said cut cards drop onto said second conveyor after being cut at the cutting station.

17. The machine of claim 16, wherein said second conveyor is timed so that the cut cards will overlap each other as they fall onto said second conveyor.

18. A machine for cutting financial cards to a non-conventional configuration, said machine comprising:
(a) a first conveyor for supplying a plurality of financial cards individually to a cutting station, said first conveyor comprising a pair of transversely spaced endless belts and a plurality of spaced nests connected to said belts for holding said financial cards during transport to a cutting station, each of said spaced nests being adapted to hold one of said financial cards therein, said first conveyor extends through said cutting station and each said financial card is cut while held within one of said nests on said first conveyor at the cutting station; and
(b) a cutting device at said cutting station for cutting said financial cards to said non-conventional configuration.

19. The machine of claim 18, wherein said cutting device includes a punch, a die block having a cavity therein and an actuator for pressing said punch into said cavity in said die block.

20. The machine of claim 19, which further comprises a second conveyor for transporting said cut financial cards away from said cutting station, said second conveyor extending transversely of said first conveyor between upper and lower portions of said first conveyor.

21. The machine of claim 21, wherein said die block is located under an upper portion of said first conveyor and said cut card may pass through said cavity in said die block onto said second conveyor.

22. A method for cutting financial cards to a non-conventional configuration, said method comprising:
(a) supplying a plurality of financial cards individually to a cutting station;
(b) cutting said financial cards to said non-conventional configuration at said cutting station; and
(c) transporting said cut financial cards away from said cutting station to a delivery station.

23. The method of claim 22, wherein said step of supplying said financial cards to a cutting station includes placing each card in a nest on a first conveyor that has a plurality of spaced nests for holding said financial cards during transport to said cutting station.

24. The method of claim 22, wherein said step of supplying said financial cards to a cutting station further comprises determining whether each card is properly placed in each nest on said first conveyor.

25. The method of claim 24, wherein said step of determining whether each card is properly placed in each nest includes using a magnetic stripe reader to determine whether the side of the card containing a magnetic stripe has been placed properly facing said magnetic stripe reader.

26. The method of claim 23, which further comprises properly locating each of said nests on said first conveyor at said cutting station to insure precision line-up of the card in said nest with a cutting device at said cutting station.

27. The method of claim 26, wherein said step of properly locating each of said nests at said cutting station includes providing at least two pilot holes in each of said nests for engagement by posts projecting from one of a pair of die sections of said cutting device.

28. The method of claim 26, wherein said step of properly locating each of said nests on said first conveyor at said cutting station includes determining the proper location of diagonally opposite corners of each of said nests at said cutting station.

29. The method of claim 22, wherein said step of cutting said cards to a non conventional configuration is selected from a group consisting of at least one of cutting said cards to a square shape, cutting said cards to an asymmetrical shape, and cutting said cards to a smaller rectangular shape.

30. The method of claim 22, wherein said financial card is selected from a group consisting of at least one of a conventional credit card, a debit card and a special value card.

31. The method of claim 22, wherein said cutting step further comprises punching a hole in each said card at said cutting station.
